(19) United States
(12) Patent Application Publication
(10) Pub. No.: US 2006/0101629 A1
(43) Pub. Date: May 18, 2006

(54) Computer-controlled milling machine for producing lenses for clip-on accessory

(75) Inventors: Avri Kvartler, Modi'in (IL); Boris Shichvarg, Haifa (IL); Zvi Feldman, Zoran (IL); Eyal Peleg, Zoran (IL)

Correspondence Address: MORGAN LEWIS & BOCKIUS LLP, 1111 PENNSYLVANIA AVENUE NW, WASHINGTON, DC, 20004, US

(73) Assignee: OPTI-CLIP INTERNATIONAL LLC

(21) Appl. No.: 11/198,391

(22) Filed: Aug. 8, 2005

Related U.S. Application Data
(63) Continuation-in-part of application No. 09/991,870, filed on Nov. 26, 2001.

(51) Int. Cl. B23B 39/00; B23P 23/00

(52) U.S. Cl. 29/26 A; 29/27 C

(57) ABSTRACT

A machine for shaping blanks to create a lens, the machine comprising a pair of worktables each to support one of the blanks to be shaped, and each to be driven by a first motor, a drill bit unit provided with a rotatable drill bit, an elevator supporting the drill bit unit and shiftable along a vertical axis to raise or lower the drill bit with respect to the blank on each worktable, and a second motor for driving the elevator, a carriage carrying said elevator and shiftable along a horizontal axis to move the drill bit back and forth with respect to said blanks, said carriage being driven by a third motor, and a processor adapted to coordinate the operation of the first, second and third motors to cause the drill bit to shape the blanks to form the lenses of a desired geometry.

This application is a Continuation in Part, and claims the benefit of U.S. application Ser. No. 09/991,870, filed on Nov. 26, 2001.

### BACKGROUND OF THE INVENTION

1. Field of the Invention

This invention relates generally to a machine adapted to mill blanks to create filter lenses for a clip-on accessory which hitches onto the frame of prescription eyeglasses having a pair of optical lenses, the filter lenses then being in registration with the optical lenses to protect the wearer of these eyeglasses from harmful radiation. More particularly, the invention relates to a computer-controlled milling machine which produces filter lenses for a clip-on accessory whose geometry matches that of the frame of the eyeglasses.

2. Status of Prior Art

An individual who is myopic (near-sighted) or hyperopic (far-sighted), or suffers from other visual defects normally wears a pair of eyeglasses in which optical lenses are mounted in a frame having temple pieces hinged thereto. The optical lenses are designed to correct for the visual defects of the wearer and are therefore usually prescribed by an optometrist or an eye doctor.

The same individual may on occasion be exposed to harmful radiation, such as intense sunlight, rays from a welding arc or from a laser beam instrument. He therefore requires sunglasses or other radiation protection glasses whose filtration characteristics depend on the nature of the harmful radiation to which the wearer is exposed.

When an individual wearing prescription eyeglasses switches to a pair of sunglasses to protect his eyes from harmful radiation, it is essential that the filter lenses of these sunglasses have the same corrective optical properties as the optical lenses in his eyeglasses—otherwise he will not see clearly through his sunglasses. However, a pair of prescription sunglasses tailored to the eyes of its wearer is at least as expensive as a costly pair of prescription eyeglasses. Hence the wearer may be reluctant or unable to bear these additional costs.

To avoid the need for prescription sunglasses, the wearer of prescription eyeglasses can convert his eyeglasses to sunglasses simply by hitching onto the frame of his eyeglasses a clip-on accessory. This accessory is provided with a pair of filter lenses that register with the optical lenses of the eyeglasses to filter out harmful radiation.

The typical clip-on is a universal accessory in the sense that it is capable of being clipped onto the frame of a pair of prescription eyeglasses regardless of the geometry or design of this frame. This is a distinct advantage, for in this era of “designer” frames, eyeglasses are now marketed in a broad range of distinctly different styles.

The disadvantage of a universal clip-on accessory which may have discouraged its more widespread use is that the standardized design of a clip-on accessory includes round filter lenses. This design is usually incompatible with the frame design of the eyeglasses onto which the accessory is hitched. It is the frame of eyeglasses that impart to eyeglasses its overall appearance. Thus if the frame is composed of trapezoidally-shaped half-sections and the filter lenses of the clip-on accessory hitched thereon are circular, the appearance of the accessory is then incongruous and unappealing.

Hence while a clip-on accessory may be said to fit onto a pair of prescription eyeglasses, it would be more realistic to say that the clip-on accessory misfits these eyeglasses and renders them unattractive.

To obviate this drawback, there is disclosed in PCT patent publication WO 95/04635 “Clip-on Sunglasses and System for Cutting Clip-on Sunglasses” a machine to custom-cut the filter lenses of the clip-on accessory so as to impart thereto the same size and shape as the half-sections of the frame of the eyeglasses onto which the clip-on is hitched. To this end, the machine includes a holder for the eyeglasses to be copied and for the clip-on, and a cutter and stylus to trace the contours of the eyeglasses and to custom-cut the clip-on in accordance with this trace.

Also disclosing a method of customizing a clip-on accessory is PCT patent publication WO 93/24856 (1993). In this method, the pair of filter lenses for the clip-on have their perimeters cut to conform to the contours of a particular pair of eyeglasses. Of prior art interest is U.S. Pat. No. 5,546,140 to Underwood which discloses a machine for custom-cutting clip-on sunglasses, the machine trimming the sunglasses to conform to the shape and size of a pair of eyeglasses.

### SUMMARY OF THE INVENTION

In view of the foregoing, the main object of this invention is to provide a computer controlled machine for milling blanks to create filter lenses for a clip-on accessory having a geometry which matches the geometry of the complementary half-sections of the eyeglass frame onto which the accessory is hitched.

By a filter lens is meant any lens adapted to cooperate with the optical lens of the eyeglasses onto which the accessory is hitched to protect the eyes of the wearer from harmful radiation, or to improve his vision. Thus the filter lens of the accessory may be an optical lens which combines with the optical lens of the eyeglasses to create a compound lens for vision correction.

Among the significant advantages in a clip-on accessory in accordance with the invention are the following:
A. The design of the clip-on accessory is fully compatible with that of the eyeglass frame onto which the clip-on is hitched whereby the attractive design of the eyeglasses is not degraded by the accessory. This is of particular value when the eyeglasses are those designed by a renowned designer and are costly.
B. Because the machine is computer-controlled, it creates a filter lens for a clip-on accessory whose geometry precisely matches that of a half-section of the frame of the eyeglasses.
C. Because the geometry of the clip-on accessory matches the geometry of the eyeglasses onto which it is hitched, it can readily be clipped onto the frame of the eyeglasses and requires no special handling.
D. The cost of manufacturing the clip-on accessory is relatively low, making it possible for the wearer of prescription eyeglasses to inexpensively convert his eyeglasses to sunglasses having the same prescription.

More particularly, it is an object of this invention to provide a milling machine in which a blank to be milled is supported on a rotary worktable to be engaged by a drilling bit that is shifted along X and Y coordinates to cut the blank to form a filter lens having the desired geometry. In the milling machine, the rotary motion of the worktable on which the blank is supported and the movements of the drill bit which act to shape the blank are computer-controlled to exactly impart the desired geometry to the blank.

Briefly stated, these objects are attained in a milling machine on whose rotary worktable is supported by a blank workpiece which is engaged by the bit of a drill bit unit mounted on an elevator. The elevator which acts to move the drill bit up and down along a vertical axis rides on a carriage movable along a horizontal track back and forth to shift the drill bit along a horizontal axis.

The rotary worktable, the elevator and the carriage are driven by respective stepping motors whose incremental advances are controlled by a computer. Digitally stored in the database of the computer is data regarding the geometry of the half-sections of the eyeglass frame on which the accessory is to be hitched. The computer acts to precisely position the drill bit with respect to the blank as it is being rotated, so as to impart thereto the desired geometry.

### BRIEF DESCRIPTION OF THE DRAWINGS

For a better understanding of the invention as well as other objects and features thereof, reference is made to the annexed drawings wherein:

FIG. 1 illustrates a clip-on accessory in accordance with the invention adapted to hitch onto a pair of prescription eyeglasses;

FIG. 2 separately shows one of the filter lenses included in the accessory;

FIG. 3 is a perspective view of the milling machine in accordance with the invention for milling blanks to create the filter lenses of the clip-on accessory;

FIG. 4 is a section taken through a transverse plane in the machine shown in FIG. 3;

FIG. 5 is a longitudinal section taken through a preferred embodiment of the drill bit unit to be included in the machine;

FIG. 6 is a perspective view of a preferred embodiment of a worktable to be included in the machine;

FIG. 7 illustrates an on-screen display in accordance with which a user may define an arbitrary lens geometry;

FIGS. 8A and 8B illustrate how the cutting of a lens may be shifted;

FIG. 9 illustrates a block adapted to retain a blank, for example on a worktable of the machine illustrated in FIG. 3;

FIG. 10A illustrates a block positioning device for use in accordance with the block illustrated in FIG. 9; and

FIG. 10B illustrates a typical use of the block positioning device illustrated in FIG. 10A.

### DETAILED DESCRIPTION OF THE INVENTION

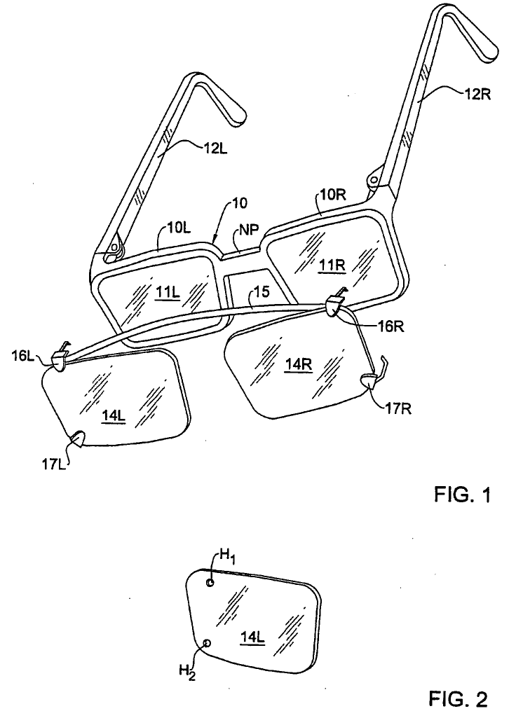

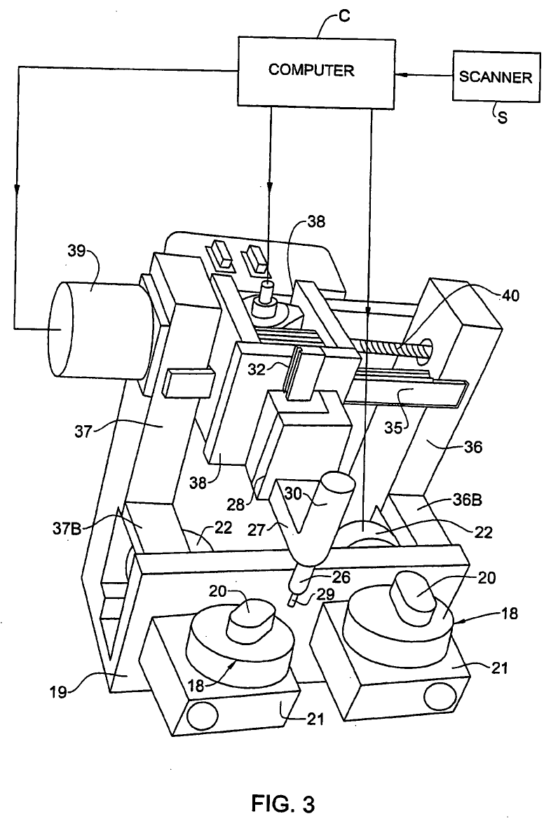

Clip-On Accessory: FIG. 1 illustrates a pair of prescription eyeglasses for correcting visual defects in the eyes of the wearer, and it also shows a clip-on accessory in accordance with the invention which is to be hitched onto these eyeglasses to protect the eyes against harmful radiation.

Included in these eyeglasses is a metal or plastic frame 10 formed by left and right half sections 10L and 10R joined together by a nosepiece NP. Mounted in the half sections of the frame are optical lenses 11L and 11R. Half sections 10L and 10R of frame 10 have a generally trapezoidal geometry, with rounded corners. The optical lenses mounted in the half sections are similarly shaped. Hinged to the half sections of the frame are temple pieces 12L and 12R.

It is to be understood that the stylized frame 10 shown in FIG. 1 is by way of example only and that whatever the actual geometry of the eyeglasses to be fitted with a clip-on accessory, the geometry of the accessory must substantially match that of the frame so that the attractiveness of the eyeglasses is not degraded by the accessory.

As shown in FIG. 1, the clip-on accessory 13 is custom-made in the sense that it fits, as it were, like a glove on the frame of the prescription eyeglasses whose stylistic geometry it has copied. In the accessory, the geometry of filter lens 14L and 14R substantially matches that of the complementary half sections 10L and 10R of the eyeglasses frame 10.

When therefore these filter lenses overlie the optical lenses of the eyeglasses, they fully cover the half sections of the frame and there is no disparity in shape and size therebetween. Hence whatever design a designer gives to the frame of prescription eyeglasses, this design is preserved by the clip-on accessory hitched onto the frame.

Filter lenses 14L and 14R of the accessory are bridged by a bridge piece 15 of a high-strength flexible metal, such as stainless steel. Piece 15 acts to position the filter lenses so that they lie in registration with the optical lenses of the eyeglasses.

Filter lenses 14L and 14R are fabricated of high-strength, synthetic plastic material having a high index of transparency, such as a polyacrylic material. The filter lenses are tinted or otherwise treated to have the desired filtration characteristics so that they filter out or reduce the harmful radiation for which the accessory is designed. Thus if the accessory is intended to convert a pair of prescription eyeglasses to sunglasses, the plastic filter lenses may be smoked or tinted for this purpose.

But for other forms of radiant energy, such as rays emanating from an arc welding device or from a laser beam instrument, the filtration characteristics must be appropriate to these rays. Or the filter lens may have optical properties which when combined with those of the optical lenses of the eyeglasses then produce a compound lens affording visual correction beyond that provided by the optical lenses alone.

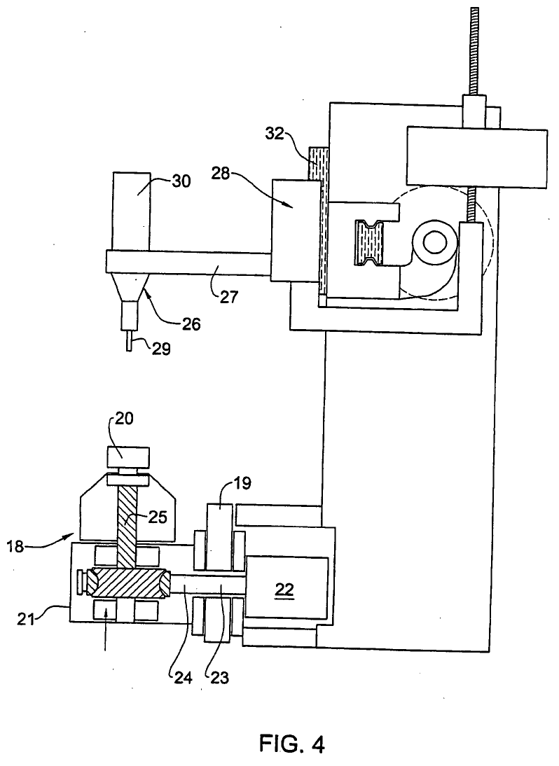

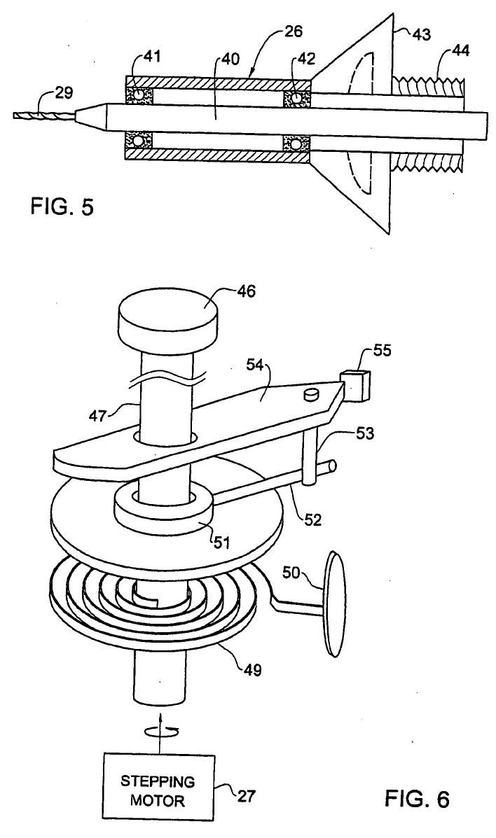

Milling Machine: The purpose of the milling machine illustrated in FIGS. 3 and 4 is to shape under computer-control a pair of blanks formed of transparent synthetic plastic material to create a pair of filter lenses for a clip-on accessory. The shaping of the blanks must be such as to impart to the resultant filter lenses substantially the same geometry as that of the half-sections of the frame of the prescription glasses onto which the accessory is to be hitched so that the style of the custom-made accessory is compatible with that of the eyeglasses.

The machine includes twin rotary worktable units 18 which support the blanks to be machined. These units are cantilevered from a vertical barrier wall 19 so that they are spaced apart at fixed and stable positions. Each unit 18 is provided with a rotary worktable 20 mounted above a gear train box 21 whose gears couple the worktable to a stepping motor 22 placed behind barrier wall 19. The shaft 23 of stepping motor 22 passes through a port in wall 19 to engage gears 24 in gear box 21, whose output shift 25 joins worktable 20 at its center.

A stepping motor is powered by a train of dc voltage pulses which cause the motor shaft to advance incrementally one angular step per pulse in a clockwise or counterclockwise direction, depending on the polarity of the pulses. These pulses are delivered to stepping motor 22 by a computer C which by controlling the number of pulses fed to the motor and their polarity can precisely position the worktable and the blank thereon to set it to a desired angular position.

Milling is carried out by a drill bit unit 26 cantilevered by an arm 27 from an elevator 28. Drill bit unit 26 includes a drill bit 29 capable of cutting and shaping plastic material as well as drilling a hole therein. It is continuously rotated at high speed by a standard dc motor 30 coupled to the drill bit unit.

It is to be noted that a unique feature of a computer-controlled milling machine in accordance with the invention is that its drill bit unit is capable of drilling, cutting, notching and engraving the blank being milled. In this way the blank is given a geometry matching that of the eyeglasses frame onto which the resultant filter lens is hitched, but the filter lens also has holes and notches by means of which clips can be anchored thereon. Engraving of the filter lens makes it possible to engrave therein a brand name or the name of the designer of the eyeglasses whose geometry is copied by the filter lens.

Elevator 28 rides on a carriage 38 that is movable back and forth on a horizontal track 35 bridging a pair of vertical pillars 36 and 37 which are parallel to the front wall 19 of the machine and are joined thereto by horizontal beams 36B and 37B. Elevator 28 rides up and down carriage 38 along a vertical rack 32 attached to the front side of carriage 38. Thus as the elevator travels up or down, it then shifts drill bit 29 of the drill bit unit 26 attached thereto along a vertical Y axis towards or away from the blank on the worktable.

Elevator 28 is driven by a stepping motor 33 powered and controlled by a train of dc pulses issuing from computer C. The number of pulses applied to the stepping motor and their polarity determines the direction and the extent to which elevator 28 is shifted in the Y direction. Carriage 38 is driven back and forth on track 25 by a stepping motor 39 mounted on vertical pillar 37, motor 39 turning a lead screw 40 which passes through threaded bores in the ends of the carriage. Stepping motor 39 is powered and controlled by a dc pulse train delivered thereto by computer C.

Thus the following three positions are controlled by computer C.
I. The vertical position of drill bit 29 relative to the blank on the worktable, as determined by elevator 28 driven by stepping motor 28.
II. The horizontal position of drill bit 29 relative to the blank, as determined by carriage 38 driven by stepping motor 39.
III. The angular position of the blank relative to the drill bit, as determined by worktable 21 driven by stepping motor 22.

Computer C which delivers a train of power pulses to each of the three stepping motors, varies the number of pulses in each train and their polarity so as to coordinate their respective operations to cause the drill bit to shape the blank being worked on to produce a filter lens of the desired geometry.

In order that the geometry of the filter lenses of the accessory match the geometry of the half-sections of the frame of the eyeglasses onto which the accessory is hitched, it is necessary to inform the computer of this geometry. This information is supplied to the computer by an electronic scanner S.

Scanner S views the pair of prescription eyeglasses whose frame geometry is to be reproduced in a clip-on accessory, and it generates a digital image thereof. The digital image is processed in the computer to derive therefrom data regarding the predetermined geometry of the frame. By predetermined is meant the geometry of the frame given to it by its designer. This data is stored in the database of the computer memory which is then able to instruct the three stepping motors of the machine to coordinate their operations so as to give the blank being shaped the desired geometry.

As an alternative to a scanner adapted to scan whatever prescription eyeglasses are brought in by a wearer to have a matching clip-on accessory made, one can store in the database of the computer the geometry of the various frames that are currently being marketed (altogether at least 500). When an individual comes in with his eyeglasses for which he wishes to obtain a clip-on accessory, the operator of the clip-on service can by looking at the frame of the eyeglasses and recognizing its style, can then extract from the database the appropriate data.

To check on whether he has selected the right data, the operator can display on the monitor screen associated with the computer an image of the selected frame geometry, and can compare this image with the frame of the spectacles for which the clip-on accessory is intended.

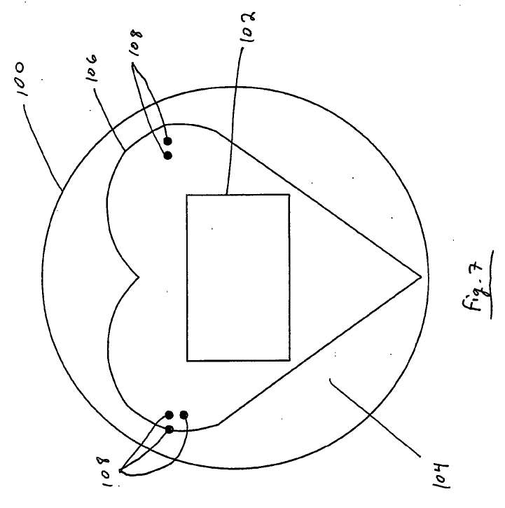

Alternatively, the digital image of the desired lens geometry may be input manually to the computer. According to one embodiment, illustrated in FIG. 7, a user is presented with an on-screen circle 100 and rectangle 102 centrally located therein. The circle 100 represents the perimeter of an uncut lens, and is thus the outer limit of the outline of a lens. The rectangle 102 represents the inner limit of the outside of the lens. (The lens outline thus must be entirely within the area 104 between the rectangle 102 and the circle 100). An input device is provided to allow the user to input a desired design 106 on the screen. The input device may be a mouse, touch screen, or any other known device.

The computer may be adapted to compute an outline from the inputted design 106. This computation may include smoothing and, in the event that the curve is not closed, closing the curve. The outline is editable, allowing a user to, inter alia, override any of the changes made by the computer to the design 106. The computer may also be preloaded with outlines. In this way, a user may select one of many pre-drawn designs without having to input it manually. The computer also allows the user to mark locations 108 where holes are to be drilled by the machine. A hole may be marked coincident with the outline in order to indicate the location of a slot. Once all computations and editing has been completed, the computer coordinates shaping of the lens from a blank. A second lens may be cut which is a mirror image of the first so that an entire pair of eyeglasses or clip-ons may be assembled using the lenses.

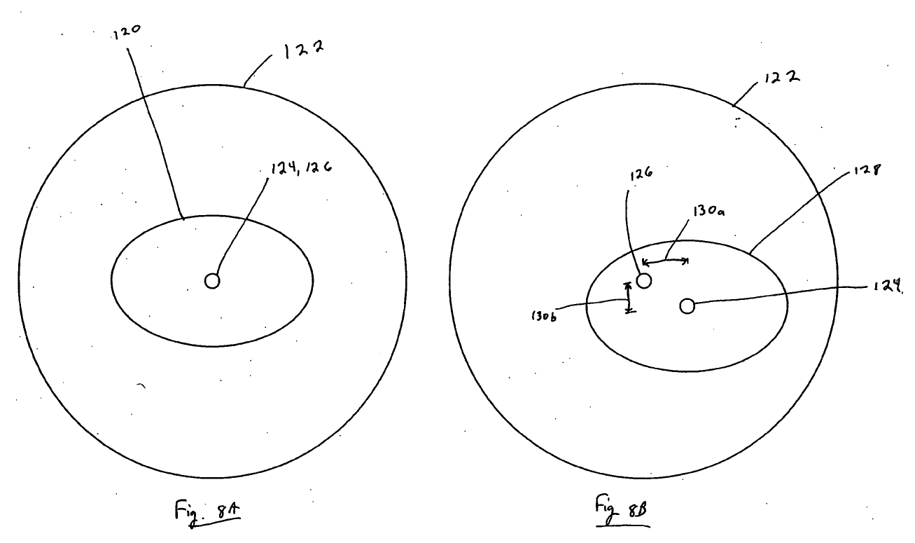

The user may also specify the horizontal and vertical offsets, if any, of the lens. This is especially useful when shaping prescription lenses. These values may be provided by an optometrist as P.D. and segH, respectively. As seen in FIG. 8A, when there is no offset provided, the computer coordinates operations of the machine to shape a lens having a perimeter which is formed along line 120 of a blank 122. The center 124 of the resulting lens is coincident with the optical axis 126 of the blank. As illustrated in FIG. 8B, when an offset is provided, the cutting is shifted according to the horizontal and vertical offsets, as indicated by arrows 130a and 130b, respectively. The computer coordinates operations of the machine to cut the lens having a perimeter which is formed along line 128. The optical axis 126 of the resulting lens can thus be located non-coincidentally with its center 124. This allows for all blanks to be secured to the worktable of the machine in the same position, without first determining the offset on the blank itself prior to shaping, as is typically done today.

In order to place the blank on the worktable in the appropriate position, a block, generally indicated at 140, is provided, as illustrated in FIG. 9. The block 140, which may be single-use, comprises a top surface 142 and a bottom surface 144. The top surface 142 is curved to match the curvature of the inner surface of a blank, and is provided with an adhesive. The adhesive should be selected such that it bonds the blank to the block during the shaping, preventing shifting, and is easily removable afterwards, preferably without leaving residue on the blank after removal.

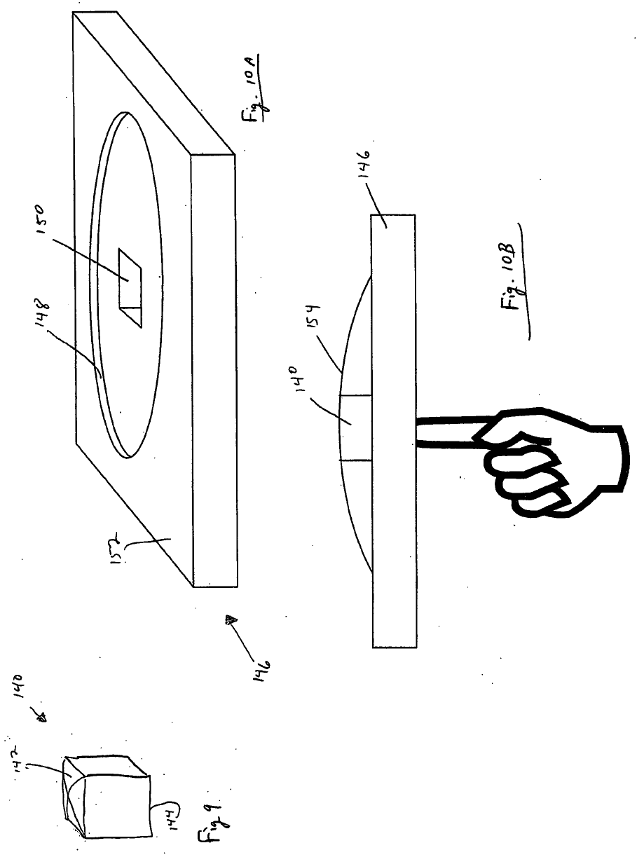

As illustrated in FIG. 10A, a block positioning device, generally designated at 146, is provided, comprising a first seat 148 and a second seat 150 on a first side 152 thereof. The first seat 148 is adapted to hold the blank, and the second seat 150, centrally located with respect to the first seat, is adapted to slidingly receive the block 140. The second seat 150 is preferably in the form of a through-going aperture shaped in accordance with the block. In use, the block 140 is placed within the second seat 150, such that its top surface 142 is disposed toward the first side 152 of the block positioning device 146. A blank 154 is placed in the first seat 148, as illustrated in FIG. 10B, and the user pushes the block 140 so that adhesive adheres thereto. A user may accomplish the pushing by inserting his finger through the second seat 150 so that it bears on the bottom surface 144 of the block 140. The blank 154 may be placed on the worktable by mounting the block 140 thereto.

In the computer-controlled machine in accordance with the invention's digital data yielded by a scanner regarding the geometry of the eyeglasses frame is stored in the database of the computer. This data instructs the milling machine so that the blank being shaped results in a filter lens whose geometry matches that of the frame. But it is also necessary to drill and notch the filter lens so that clips can be anchored therein to hitch the filter lens onto the frame. For this purpose the computer is provided with software that instructs the milling machine to drill and notch the filter lens at the proper positions.

Worktable: In order for the worktable in the milling machine to precisely position a blank work piece supported on the table driven by a stepping motor, it is essential that when the rotary worktable is shifted to a particular angular position, that it then maintains this position. Should there be “play” in the drive mechanism (freedom to deviate slightly away from the set position) then this tolerance will adversely affect the shaping precision of the machine.

To eliminate this play, the worktable 46 shown in FIG. 6 is mounted on a shaft 47 driven by a stepping motor 48 to turn incrementally in the counterclockwise direction. Surrounding shaft 47 is a spiral spring 49 formed of spring metal, the inner end of the spring being joined to the shaft and the outer end to a fixed body 50 in the machine. Thus each time shaft 49 is caused to turn one step by stepping motor 48, spiral spring 49 is wound to tighten it.

As a consequence the shaft is subjected by the spring to a tension force that holds the turntable at its set position and prevents it from deviating therefrom. With successive steps of the motor which incrementally advance the worktable, the spring is further tightened until a point is reached at which it is fully tightened and therefore cannot continue to be tightened.

In order to release the fully-tightened spring so that it can resume its function to prevent play of the worktable, there is fixedly mounted on shaft 47 a ring 51. Projecting horizontally from this ring is a rod 52 which is joined to a vertical finger 53 connected to the end of a pointer arm 54 that is free to swing about shaft 47.

When the spring is being tightened this causes pointer arm 54 to swing in a counterclockwise direction until it strikes the actuator 54 of a spring-release mechanism which is actuated when the spiral spring is fully tightened and movement of the shaft is then arrested. The resultant unwinding of the spring makes it possible to resume the worktable operation.

While there has been shown preferred embodiments of a milling machine in accordance with the invention, it is to be understood that many changes may be made therein without departing from the spirit of the invention.

Thus when the prescription eyeglasses having a pair of optical lenses is “rimless” and therefore has no separate frame, the clip-on accessory having a pair of filter lenses hitches onto the borders of the optical lenses. These borders effectively function as the frame of the eyeglasses, and the geometry of these framing borders must be matched by the filter lenses of the accessory.

1. A machine for shaping blanks to create a lens; said machine comprising:
(a) a pair of worktables each to support one of the blanks to be shaped, and each to be driven by a first motor;
(b) a drill bit unit provided with a rotatable drill bit;
(c) an elevator supporting said drill bit unit and shiftable along a vertical axis to raise or lower the drill bit with respect to the blank on each worktable, and a second motor for driving the elevator;
(d) a carriage carrying said elevator and shiftable along a horizontal axis to move the drill bit back and forth with respect to said blanks, said carriage being driven by a third motor; and
(e) a processor including a digitally stored database in which is stored digital data regarding the predetermined geometry of the frame of the eyeglasses, from which data to the processor coordinates the operation of the first, second and third motors to cause said drill bit to shape the blanks to form the lenses of a desired geometry;
wherein the processor is adapted to calculate the geometry based on a design acquired via a user input device which allows a user to freely input the design based on the user's motion.

2. A machine according to claim 1, wherein the user input device is a computer mouse.

3. A machine according to claim 1, wherein the user input device is a touch-sensitive screen.

4. A machine according to claim 1, wherein the user input device is a keyboard.

5. A machine according to claim 1, further adapted to calculate an editable outline from the design, said coordination being such that the lens is substantially the same shape as the editable outline.

6. A machine according to claim 1, wherein locations of holes within the lens may be specified via the user input device.

7. A machine according to claim 1, wherein the lens is a filter lens.

8. A method for shaping a blank to create a lens using a machine and a computer, the machine being adapted for the shaping and having a worktable adapted to support the blank during the shaping, the computer being adapted for coordination of operation of the machine, the method comprising the steps of:
(a) providing an outline in accordance with which the blank is to be cut;
(b) providing at least one non-zero horizontal or vertical offset of the lens;
(c) positioning the blank on the worktable; and
(d) cutting the blank along a perimeter of the lens which is in accordance with the outline;
wherein the location of the perimeter within the blank is shifted in accordance with the at least one offset.

9. A method according to claim 8, wherein the horizontal and vertical offsets are determined, respectively, by the horizontal and vertical distances of the pupil of a user from the optical axis of a lens formed by a blank cut along the perimeter without the shifting.

10. A method according to claim 8, wherein a block is provided, said block adapted at a first side to adhere to the lens, and at a second side to be fixedly mounted on a central portion of the worktable, said positioning being accomplished by adhering the block to the center of the blank and mounting it on the worktable.

11. A method according to claim 10, wherein block positioning device, adapted for positioning the block so that it is centrally located with respect to the blank, is provided, said block positioning device comprising a first seat and a second seat centrally located to the first seat, said first seat adapted to snuggly receive the blank, and said second seat adapted to snuggly receive the block.

12. A machine for shaping blanks to create a lens, comprising a processor adapted to coordinate its operation in accordance with the method of claim 8.

13. A machine for shaping blanks to create a lens; said machine comprising:
(a) a pair of worktables each to support one of the blanks to be shaped, and each to be driven by a first motor;
(b) a drill bit unit provided with a rotatable drill bit;
(c) an elevator supporting said drill bit unit and shiftable along a vertical axis to raise or lower the drill bit with respect to the blank on each worktable, and a second motor for driving the elevator;
(d) a carriage carrying said elevator and shiftable along a horizontal axis to move the drill bit back and forth with respect to said blanks, said carriage being driven by a third motor; and
(e) a processor including a digitally stored database in which is stored digital data regarding the predetermined geometry of the frame of the eyeglasses, from which data to the processor coordinates the operation of the first, second and third motors to cause said drill bit to shape the blanks to form the lenses of a desired geometry.
